(19) United States
(12) Patent Application Publication
(10) Pub. No.: US 2021/0368049 A1
(43) Pub. Date: Nov. 25, 2021

(54) SYSTEM, CONTROL METHOD OF SYSTEM, TERMINAL DEVICE, AND NON-TRANSITORY COMPUTER-READABLE STORAGE MEDIUM

(71) Applicant: CANON KABUSHIKI KAISHA, Tokyo (JP)

(72) Inventor: Tomohide Kubota, Kanagawa (JP)

(21) Appl. No.: 17/319,429

(22) Filed: May 13, 2021

(30) Foreign Application Priority Data
May 25, 2020 (JP) 2020-090826

(51) Int. Cl. H04N 1/00; G06F 3/12

(52) U.S. Cl. CPC H04N 1/00342; G06F 3/1204; G06F 3/1284; G06F 3/1238; G06F 3/1222

(57) ABSTRACT

It is to provide technology for enabling printing based on password-protected print data held at the image forming device to be performed in simple method from an external terminal. The terminal device transmits a print instruction including user information of a user of the terminal device to the image forming device in a case where near field communication with the image forming device is established. The image forming device identifies print data corresponding to the user information included in the print instruction from among a plurality of held print data and controls printing based on the identified print data on the basis of a password for printing.

### BACKGROUND OF THE INVENTION

### Field of the Invention

The present invention relates to printing technology.

### Description of the Related Art

When a known image forming device receives print data from a terminal device such as a personal computer (PC), the image forming device immediately performs printing. In this case, this may lead to information being leaked due to a third party seeing a print article which has been left without being picked up. In recent years, a hold printing system has been developed that, for confidentiality reasons, holds print data in a non-volatile storage area of an image forming device instead of immediately performing printing when the print data is received, and then, when the user instructs printing on an operation unit of the image forming device, printing is performed.

Also, in recent years, high performance portable terminals known as smart phones have become more common, and applications (referred to as MFP applications below) that provide a print function and a scan function on the portable terminal have been developed. With such MFP applications, it is possible to transmit print data, instruct scan function execution to an image forming device wirelessly connected to the portable terminal, and the like.

A technology (Japanese Patent Laid-Open No. 2016-058072) has proposed in which, identification ID information of a portable terminal is caused to be included in print data, transmitted from the portable terminal to the image forming device, and held there, and a print instruction together with the identification ID information is sent via near field communication from the portable terminal to the image forming device, whereby corresponding print data is printed.

However, the known technology has a problem in that, while print data held from the portable terminal can be easily printed, a print instruction cannot be issued from the portable terminal for print data held and protected by a password, i.e., secure printing from an information processing device such as a PC.

### SUMMARY OF THE INVENTION

The present invention provides technology for enabling printing based on password-protected print data held at the image forming device to be performed in simple method from an external terminal.

According to the first aspect of the present invention, there is provided a system comprising devices that include an image forming device and a terminal device: wherein the terminal device comprises: a first memory; and a first processor in communication with the first memory, wherein the first processor transmits a print instruction including user information of a user of the terminal device to the image forming device in a case where near field communication with the image forming device is established; and wherein the image forming device comprises: a second memory; and a second processor in communication with the second memory, wherein the second processor identifies print data corresponding to the user information included in the print instruction from among a plurality of held print data and controls printing based on the identified print data on the basis of a password for printing.

According to the second aspect of the present invention, there is provided a control method of a system comprising devices that include an image forming device and a terminal device, wherein the terminal device transmits a print instruction including user information of a user of the terminal device to the image forming device in a case where near field communication with the image forming device is established; and wherein the image forming device identifies print data corresponding to the user information included in the print instruction from among a plurality of held print data and controls printing based on the identified print data on the basis of a password for printing.

According to the third aspect of the present invention, there is provided a terminal device for communicating with an image forming device, comprising: a memory; and a processor in communication with the memory, wherein the processor performs: receiving input of user information and a password; and transmitting a print instruction including the password and the user information to the image forming device.

According to the fourth aspect of the present invention, there is provided a non-transitory computer-readable storage medium for storing a computer program for causing a computer of a terminal device for communicating with an image forming device to function as: a reception unit configured to receive input of user information and a password; and a transmission unit configured to transmit a print instruction including the password and the user information whose input is received by the reception unit to the image forming device.

Further features of the present invention will become apparent from the following description of exemplary embodiments with reference to the attached drawings.

### BRIEF DESCRIPTION OF THE DRAWINGS

FIG. 1 is a diagram illustrating an example configuration of a printing system.

FIG. 2 is a block diagram illustrating an example hardware configuration of a data processing device 101.

FIG. 3 is a block diagram illustrating an example hardware configuration of an image forming device 104.

FIG. 4 is a block diagram illustrating an example functional configuration of the data processing device 101.

FIG. 5 is a block diagram illustrating an example functional configuration of the image forming device 104.

FIG. 6 is a flowchart illustrating a series of sequences for making the image forming device 104 print the secure print data of a user operating the data processing device 101.

FIG. 7A is a diagram illustrating an example display of a screen of a display 214.

FIG. 7B is a diagram illustrating an example display of a screen of a display 214.

FIG. 7C is a diagram illustrating an example display of a screen of a display 214.

FIG. 7D is a diagram illustrating an example display of a screen of a display 214.

FIG. 7E is a diagram illustrating an example display of a screen of a display 214.

FIG. 7F is a diagram illustrating an example display of a screen of a display 214.

FIG. 8 is a flowchart illustrating the operations of the data processing device 101.

FIG. 9 is a flowchart illustrating the operations of the image forming device 104.

FIG. 10 is a diagram illustrating an example configuration of a table 1001.

FIG. 11 is a flowchart of the operations of the data processing device 101.

FIG. 12 is a flowchart of the operations of the image forming device 104.

FIG. 13 is a diagram illustrating an example configuration of a secure password input screen 1302.

FIG. 14 is a flowchart of the processing executed by the data processing device 101 to set the password for secure print data at the password settings screen.

FIG. 15A is a diagram illustrating an example display of a screen of a display 214.

FIG. 15B is a diagram illustrating an example display of a screen of a display 214.

FIG. 16 is a flowchart of the processing executed by the data processing device 101 to transmit a print instruction to the image forming device 104.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

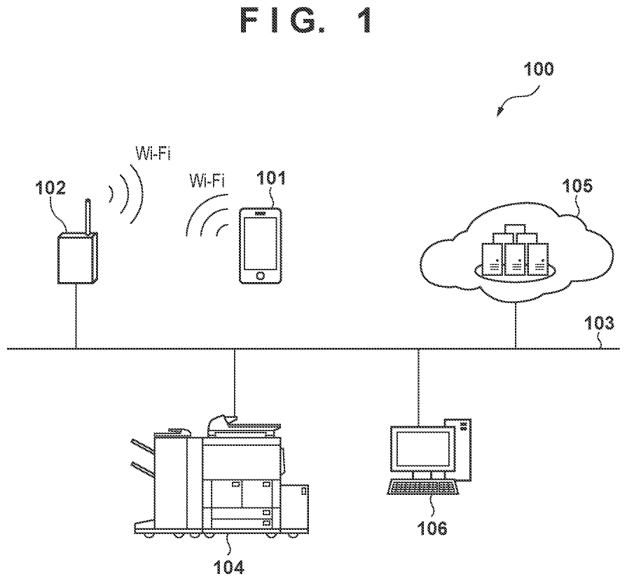

First, an example configuration of a printing system according to the present embodiment will be described using FIG. 1. As illustrated in FIG. 1, a printing system 100 according to the present embodiment includes a data processing device 101, a wireless LAN terminal 102, an image forming device 104, a cloud server 105, and an information processing device 106. These devices are connected to one another via a wired network 103.

First, the data processing device 101 will be described. The data processing device 101 is a mobile terminal (terminal device), such as a smart phone, a tablet terminal device, a laptop personal computer (PC), or the like. In such the data processing device 101, an operating system (OS) for a small terminal and computer programs for controlling calling and data communications may be executed. Also, such the data processing device 101 may be a PC without audio control, position detection control, mobile phone data communication, and the like. The data processing device 101 is capable of wireless communication via WiFi with the wireless LAN terminal 102. Because the wireless LAN terminal 102 is connected on the network 103, the data processing device 101 is capable of wireless LAN communications with devices on the network 103 via the wireless LAN terminal 102.

Next, the wireless LAN terminal 102 will be described. The wireless LAN terminal 102 is a master unit for wireless LAN with a typical network and router function that provides wireless LAN via WiFi to a home or office.

Next, the image forming device 104 will be described. The image forming device 104 is a multi-function peripheral capable of executing jobs of various functions, such as a print function, a copy function, a scanner function, a facsimile transmission function, and the like. The user can operate the data processing device 101 to instruct to the image forming device 104 to execute a job of one of the various functions. When the image forming device 104 receives the instruction, it executes the job of the corresponding function.

The data processing device 101 and the image forming device 104 are capable of communicating data between one another via a near field communication, such as Near Field Communication (NFC), Bluetooth Low Energy (BLE), or the like. The image forming device 104 includes, in a NFC communication unit 310 and a BLE communication unit 311 described below, device information (IP address, MAC address, or the like) for connecting via wireless LAN to the image forming device 104, and the data processing device 101 obtains connection information via near field communication. On the basis of the obtained connection information, wireless communication is opened between the data processing device 101 and the image forming device 104. For example, by switching (referred to as handover) from the connection information obtained via NFC or BLE near field communication between devices to wireless LAN communication such as WiFi, wireless LAN communications are established between the data processing device 101 and the image forming device 104.

Next, the cloud server 105 will be described. The cloud server 105 performs management of data used by the data processing device 101 and the image forming device 104, scaling processing of various functions, and the like via the network 103.

Next, the information processing device 106 will be described. The information processing device 106 is a PC that is capable of transmitting print data to the image forming device 104 via the network 103 and making the image forming device 104 hold the print data.

Note that as illustrated in FIG. 1, the devices such as the image forming device 104, the cloud server 105, and the information processing device 106 are connected directly to the wired network 103. However, these devices may perform wireless communication between other devices on the network 103 via the wireless LAN terminal 102 in a similar manner to the data processing device 101.

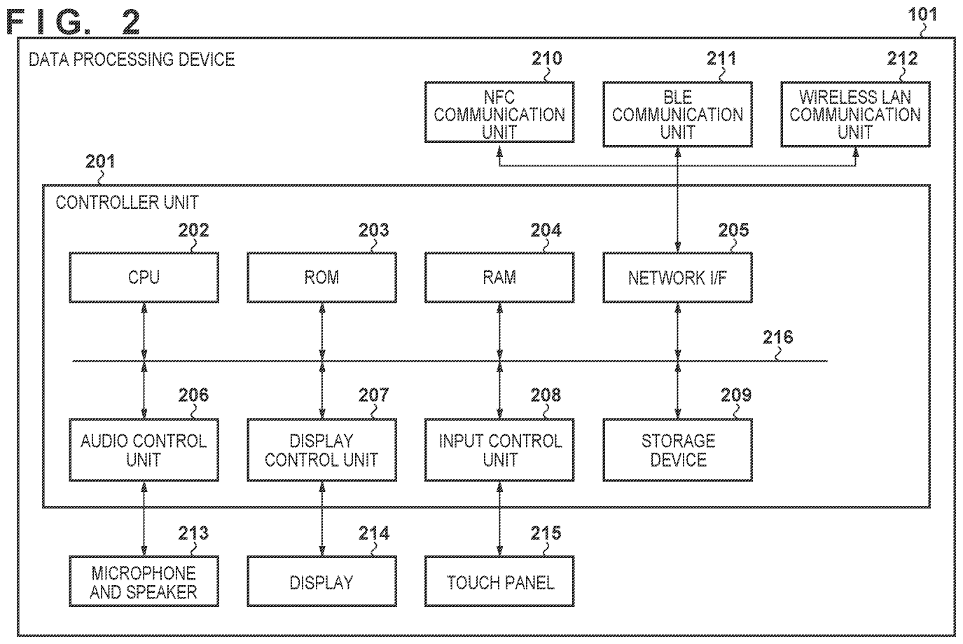

Next, an example of the hardware configuration of the data processing device 101 will be described using the block diagram of FIG. 2. Note that the configuration illustrated in FIG. 2 is merely an example of a hardware configuration applicable to the data processing device 101, and limiting to this configuration is not intended.

As illustrated in FIG. 2, the data processing device 101 includes a controller unit 201, an NFC communication unit 210, a BLE communication unit 211, a wireless LAN communication unit 212, a microphone and speaker 213, a display 214, and a touch panel 215.

First, the controller unit 201 will be described. The controller unit 201 performs operation control of the NFC communication unit 210, the BLE communication unit 211, the wireless LAN communication unit 212, the microphone and speaker 213, the display 214, and the touch panel 215 and performed operation control of the entire data processing device 101.

A CPU 202 executes various processing using computer programs and data stored in ROM 203 and RAM 204. Accordingly, the CPU 202 performs operation control of the entire data processing device 101 and executes or controls various processing described below as processing executed by the data processing device 101.

Setting data of the data processing device 101, computer programs and data associated with activating the data processing device 101, computer programs and data associated with basic operation of the data processing device 101, and the like are stored in the ROM 203. The computer programs and data stored on the ROM 203 include, for example, an OS, computer programs and data associated with calling, computer programs and data associated with data communication. Also, the computer programs and data stored on the ROM 203 include, for example, the computer programs and data for making the CPU 202 execute or control various processing described below as processing executed by the data processing device 101.

The RAM 204 includes an area for storing the computer programs and data loaded from the ROM 203 or a storage device 209 and data the NFC communication unit 210, the BLE communication unit 211, and the wireless LAN communication unit 212 receive from an external device. Also, the RAM 204 includes an area for storing data of audio input from the microphone and speaker 213 via an audio control unit 206. Also, the RAM 204 includes a working area used in the execution of various processing by the CPU 202. In this way, the RAM 204 can provide various areas as appropriate.

A network I/F 205 is an interface for communications between the controller unit 201 and the NFC communication unit 210, the BLE communication unit 211, and the wireless LAN communication unit 212.

The audio control unit 206 is connected with the microphone and speaker 213 and performs operation control of the microphone and speaker 213. A display control unit 207 is connected with the display 214 and performs operation control of the display 214.

An input control unit 208 is connected with the touch panel 215. The input control unit 208 detects an operation input by a user via the touch panel 215 and notifies the controller unit 201 of the detection result.

The storage device 209 is a non-volatile storage device that stores various information (various operation mode settings, operation logs, and the like) required to be stored even after the data processing device 101 is restarted. Note that some of the computer programs and data described as being stored on the ROM 203 may be stored in the storage device 209, and which computer programs and data are stored in which memory device is not limited to a specific form. This is the same for other devices.

The above described CPU 202, the ROM 203, the RAM 204, the network OF 205, the audio control unit 206, the display control unit 207, the input control unit 208, and the storage device 209 are all connected to a system bus 216.

Next, the NFC communication unit 210, the BLE communication unit 211, and the wireless LAN communication unit 212 will be described. All of the NFC communication unit 210 and the BLE communication unit 211 perform near field communication with the image forming device 104. The wireless LAN communication unit 212 communicates via a wireless LAN with the devices on the network 103 via the wireless LAN terminal 102.

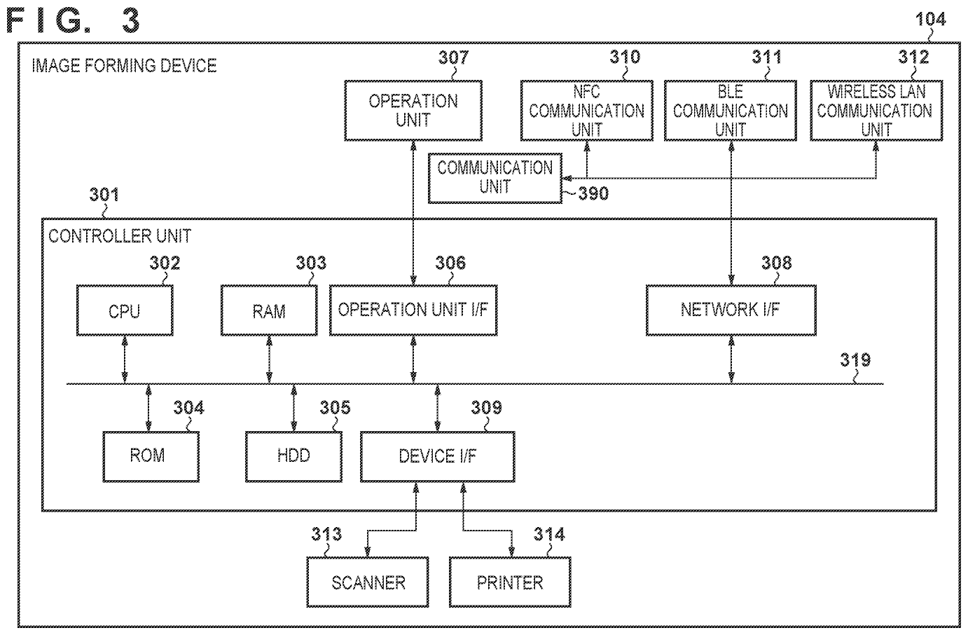

Next, an example of the hardware configuration of the image forming device 104 will be described using the block diagram of FIG. 3. Note that the configuration illustrated in FIG. 3 is merely an example of a hardware configuration applicable to the image forming device 104, and limiting to this configuration is not intended.

As illustrated in FIG. 3, the image forming device 104 includes a controller unit 301, an operation unit 307, the NFC communication unit 310, the BLE communication unit 311, a wireless LAN communication unit 312, a communication unit 390, a scanner 313, and a printer 314.

First, the controller unit 301 will be described. The controller unit 301 performs operation control of the operation unit 307, the NFC communication unit 310, the BLE communication unit 311, the wireless LAN communication unit 312, the communication unit 390, the scanner 313, and the printer 314, as well as performing operation control of the entire image forming device 104.

A CPU 302 executes various processing using computer programs and data stored in RAM 303 and ROM 304. Accordingly, the CPU 302 performs operation control of the entire image forming device 104 and executes or controls various processing described below as processing executed by the image forming device 104.

The RAM 303 includes an area for storing computer programs and data loaded from the ROM 304 or a hard disk drive (HDD) 305. Also, the RAM 303 includes an area for storing data received by the NFC communication unit 310, the BLE communication unit 311, the wireless LAN communication unit 312, and the communication unit 390 from an external device. Also, the RAM 303 includes an area for storing a read image of a document read by the scanner 313. Also, the RAM 303 includes a working area used in the execution of various processing by the CPU 302. In this way, the RAM 303 can provide various areas as appropriate.

Setting data of the image forming device 104, computer programs and data associated with activating the image forming device 104, computer programs and data associated with basic operation of the image forming device 104, and the like are stored in the ROM 304.

An OS and computer programs and data for making the CPU 302 execute or control various processing described as processing executed by the image forming device 104 are stored in a HDD 305. The computer programs and data stored in the HDD 305 are loaded on the RAM 303 according to control by the CPU 302 as appropriate and targets to be processed by the CPU 302.

An operation unit I/F 306 is an interface for communications between the controller unit 301 and the operation unit 307. A network I/F 308 is an interface for communications between the controller unit 301 and the NFC communication unit 310, the BLE communication unit 311, the wireless LAN communication unit 312, and the communication unit 390. A device I/F 309 is an interface for communications between the controller unit 301 and the scanner 313 and the printer 314.

The described above CPU 302, the RAM 303, the ROM 304, the HDD 305, the operation unit I/F 306, the device I/F 309, and the network I/F 308 are all connected to a system bus 319.

Next, the operation unit 307 will be described. The operation unit 307 includes a touch panel screen, a button group, and the like. The operation unit 307 receives various operation inputs from a user via the touch panel screen, button group, and the like and displays on the touch panel screen the processing result obtained by the controller unit 301 as images, characters, and the like.

Next, the NFC communication unit 310, the BLE communication unit 311, the wireless LAN communication unit 312, and the communication unit 390 will be described. All of the NFC communication unit 310 and the BLE communication unit 311 communicate with the data processing device 101 via near field communication. The wireless LAN communication unit 312 communicatees via a wireless LAN with external devices. The communication unit 390 performs data communications with devices on the network 103.

Next, the scanner 313 will be described. The scanner 313 reads a document placed on a document platform provided in the image forming device 104 or attached to the image forming device 104, generates a read image of the document, and outputs the generated read image to the controller unit 301.

Next, the printer 314 will be described. The printer 314 prints an image on a printing medium such as paper on the basis of an input image and discharges the printing medium printed on to a set discharge destination.

In a case where a user operates the operation unit 307 or operates the data processing device 101 or the information processing device 106 and instructs to copy to the image forming device 104, the controller unit 301 controls the scanner 313 and the printer 314 to implement the copy function described below. With the copy function, the scanner 313 reads the document to generate a read image of the document and outputs the generated read image to the printer 314. The printer 314 prints the read image on a printing medium and discharges the printing medium to a set discharge destination.

Also, in a case where a user operates the operation unit 307 or operates the data processing device 101 or the information processing device 106 and instructs to scan to the image forming device 104, the controller unit 301 controls the scanner 313 to implement the scan function described below. With the scan function, the scanner 313 reads the document to generate a read image of the document and converts the read image into code data. The scanner 313 then transmits the code data to a preset transmission destination, such as the data processing device 101 or the cloud server 105, via the network 103.

Also, in a case where a user operates the operation unit 307 or operates the data processing device 101 or the information processing device 106 and instructs to a print to the image forming device 104, the controller unit 301 controls the printer 314, the NFC communication unit 310, the BLE communication unit 311, the wireless LAN communication unit 312, and the communication unit 390 to implement the print function described below. With the print function, the controller unit 301 controls the NFC communication unit 310, the BLE communication unit 311, the wireless LAN communication unit 312, and the communication unit 390 and receives a print data from the data processing device 101, the cloud server 105, the information processing device 106, or the like via the network 103. Also, the controller unit 301 stores (holds) the received print data in the HDD 305 and remains on standby to print based on the print data until a print instruction is received. When the controller unit 301 receives a print instruction, the controller unit 301 executes authentication in a case where the print data subject to the print instruction is “print data set with a password for printing (secure print data)”. In a case where authentication is successful, the controller unit 301 converts the print data into a print image and outputs the print image to the printer 314. On the other hand, in a case where the print data subject to the print instruction is “print data not set with a password for printing (unsecure print data)”, the controller unit 301 converts the print data into a print image without executing the authentication described above and outputs the print image to the printer 314. The printer 314 prints the print image received from the controller unit 301 on a printing medium and discharges the printing medium. Also, the image forming device 104 includes a facsimile reception function in which data is received from an ISDN or the like to be printed and a facsimile transmission function in which scanned data is transmitted to, ISDN, or the like.

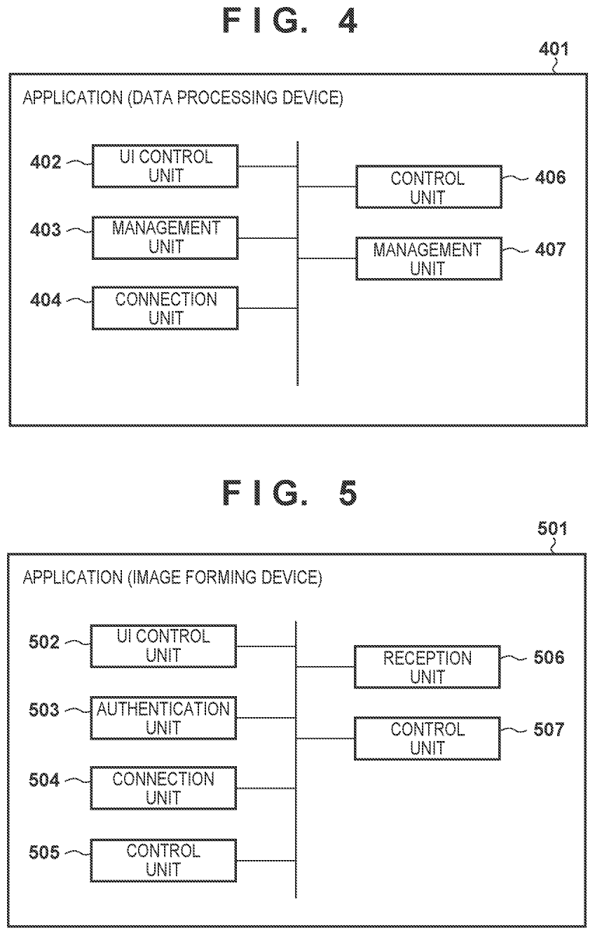

An example of the functional configuration of the data processing device 101 will be described using the block diagram of FIG. 4. In the present embodiment, the functional units illustrated in FIG. 4 are all implemented by a computer program. In the example below, the functional units illustrated in FIG. 4 may be described as the processing subjects. However in reality, the functions corresponding to the functional units are implemented by the CPU 202 executing computer programs corresponding to the functional units. Note that the functional units illustrated in FIG. 4 may be implemented by hardware.

An application 401 is an application for a user to operate the data processing device 101 and make the image forming device 104 execute printing based on the print data of the user. The application 401 is stored in the storage device 209 and is read out on the RAM 204 and executed by the CPU 202.

A UI control unit 402 receives a user operation by a user performed on the touch panel 215 via the input control unit 208, controls the display control unit 207 according to the user operation, and performs display control of the screen of the display 214.

A management unit 403 obtains the user information input by the user on the touch panel 215 via user operation and manages the user information as authentication information used in authenticating the user.

A connection unit 404 controls the NFC communication unit 210/the BLE communication unit 211 and performs near field communication with the image forming device 104 to obtain the device information of the image forming device 104 and establishes wireless LAN communications via the network 103. For example, in the case of NFC, near field communication is started when the user brings the NFC communication unit 210 of the data processing device 101 into contact with the NFC communication unit 310 of the image forming device 104. Also, in the case of BLE, near field communication is started when the user brings the BLE communication unit 211 of the data processing device 101 into close proximity with the BLE communication unit 311 of the image forming device 104 and the connection unit 404 determines that it positioned within a distance in which the strength of the BLE is equal to or more than a certain strength. In this manner, when a user performs an operation (referred to as a touch operation) to bring the NFC or BLE communication unit of the image forming device 104 into close proximity with the NFC or BLE communication unit of the data processing device 101, the connection unit 404 obtains the device information of the image forming device 104. Also, the data processing device 101 starts a wireless LAN connection with the image forming device 104 via the network 103 from the obtained device information.

When near field communication is established with the image forming device 104, the control unit 406 controls the wireless LAN communication unit 212 and transmits a print instruction to the image forming device 104. A print instruction command being a command instructing for execution of printing, and user information managed by the management unit 403 are included in the print instruction. Note that in a case where the print data which is the target of a print instruction is secure print data, the user inputs a password for the secure print data at the data processing device 101. Accordingly, the control unit 406 also includes a password for secure print data in the print instruction.

A management unit 407 obtains and manages the password for secure print data input by the user operating the touch panel 215. The password for secure print data is included in the print instruction described above and transmitted to the image forming device 104.

Next, an example of the functional configuration of the image forming device 104 will be described using the block diagram of FIG. 5. In the present embodiment, the functional units illustrated in FIG. 5 are all implemented by a computer program. In the example below, the functional units illustrated in FIG. 5 may be described as the processing subjects. However in reality, the functions corresponding to the functional units are implemented by the CPU 302 executing computer programs corresponding to the functional units. Note that the functional units illustrated in FIG. 5 may be implemented by hardware.

An application 501 is an application for printing print data corresponding to a print instruction received from the data processing device 101 from among a plurality of print data stored (held) in the HDD 305. The application 501 is stored in the HDD 305 and is read out on the RAM 303 and executed by the CPU 302.

A UI control unit 502 receives a user operation by a user performed on the operation unit 307 via the operation unit I/F 306, controls the touch panel screen of the operation unit 307 according to the user operation, and performs display control of the touch panel screen.

An authentication unit 503 performs user authentication on the basis of user information included in the print instruction received from the data processing device 101. A connection unit 504 controls the NFC communication unit 310 or the BLE communication unit 311 of the image forming device 104 and transmits the device information to the data processing device 101. A control unit 505 controls the NFC communication unit 310 or the BLE communication unit 311 and receives the print instruction transmitted from the data processing device 101.

A reception unit 506 receives print data transmitted from various devices such as the data processing device 101, the cloud server 105, the information processing device 106, and stores (registers) the received print data in the HDD 305. The print data is stored (registered) in the HDD 305 together with the user information (for example, user name) of the device that transmitted the print data.

A control unit 507 obtains the print data corresponding to the user information included in the print instruction received from the data processing device 101 from the print data group stored (registered) in the HDD 305. The control unit 507 generates a print image based on the print data obtained according to a print instruction command included in the print instruction or according to the print instruction input via a user operating the operation unit 307 and makes the printer 314 print the print image.

A method of executing printing processing of secure print data via a user operating the image forming device 104 will be described. First, a case where the image forming device 104 is operated under an authenticated environment will be described. A user who has transmitted secure print data set with a password logs into the image forming device 104 by inputting the user information and the like on the image forming device 104. The user selects the desired print data from the list of print data associated with the logged-in user and inputs the password for secure print data set in the print data on the image forming device 104 to allow to execute printing processing of the secure print data. Next, a case where the image forming device 104 is operated under a non-authenticated environment will be described. A user who has transmitted secure print data selects their own print data on the image forming device 104 from the list of print data that the print data of other users is included and inputs the password for secure print data set in the print data on the image forming device 104 to allow to execute printing processing of the secure print data. In the examples described above, the user has to perform an operation such as selection of the print data to be executed in front of the image forming device 104 and inputting of the password for secure print data, and the time spent in front of the image forming device 104 increases. In the present embodiment, a case where the user information (and the password for secure print data) is preset in the data processing device 101, and, by only making the data processing device 101 and the image forming device 104 communicate with one another, the print data corresponding to the user information set in the data processing device 101 can be executed by the image forming device 104 on the basis of the password for secure print data is provided. Note that in a case where the image forming device 104 operates under an authenticated environment, the user information set in the data processing device 101 is used in logging in to the image forming device 104 and in identifying the job associated with the user. In a case where the image forming device 104 operates under an authenticated environment, the user information set in the data processing device 101 is used in identifying the job associated with the user.

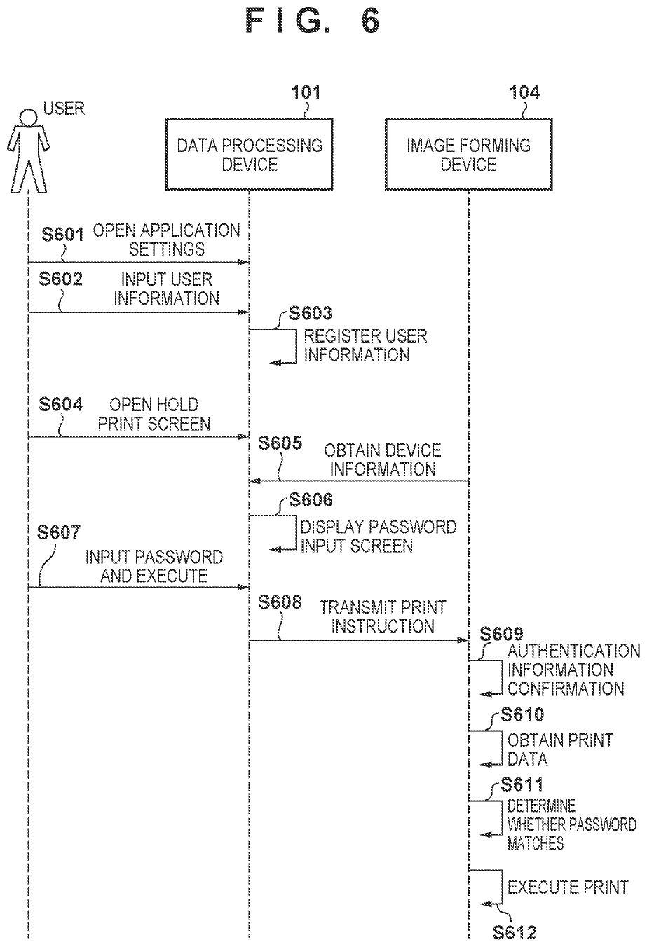

Next, a series of sequences for making the image forming device 104 print the secure print data of a user by the user operating the data processing device 101 will be described with reference to the flowchart of FIG. 6.

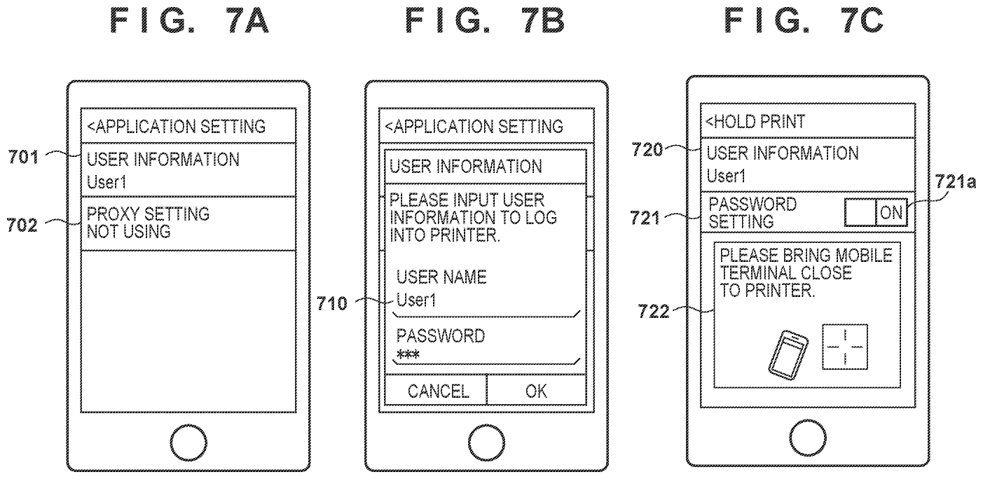

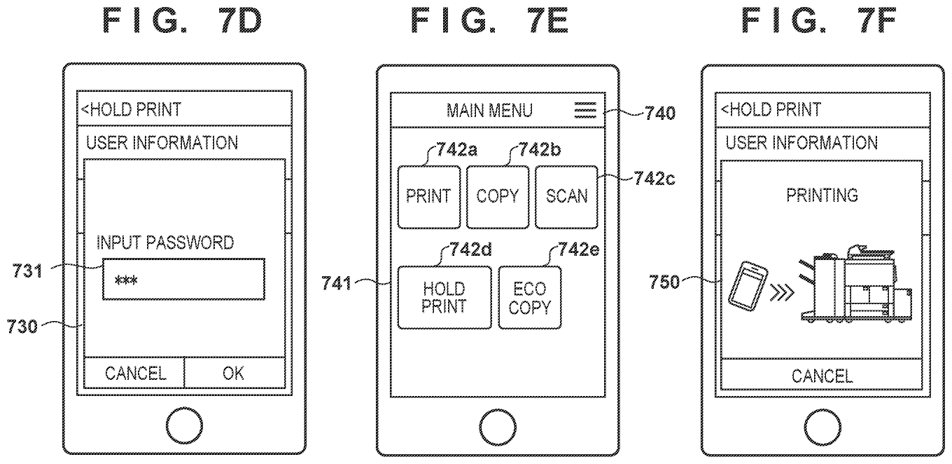

At the starting point in step S601, a “main screen 741 of the application 401” illustrated in FIG. 7E is displayed on the display 214 of the data processing device 101. Icons 742a to 742e on the main screen 741 correspond to functions executable by the application 401. For example, when the user touches the icon 742a, execution of the print function can be instructed to the data processing device 101. A button 740 is a button for instructing to perform the settings of the application 401.

When a user touches (instructs) the button 740, in step S601, the UI control unit 402 displays a “application settings screen of the application 401” illustrated in FIG. 7A on the display 214.

On the application settings screen, a button 701 is a button for instructing to set the user information, and a button 702 is a button for instructing to set the proxy. Note that the configuration of the application settings screen illustrated in FIG. 7A is an example, and, for example, only the button 701 may be displayed or buttons for instructing other settings may be displayed furthermore.

When a user touches the button 701, in step S602, the UI control unit 402 displays a user information input screen 710 illustrated in FIG. 7B on the display 214 and receives input of the user information. The user information input screen 710 is provided with fields for inputting a user name and password as user information, and thus a user operates the touch panel 215 to input their own user name and password to respective fields. Note that in a case where the image forming device 104 is set not to perform authentication, input of a password is not required.

When the user touches the OK button after inputting a user name and password, in step S603, the management unit 403 manages (registers) the user information including the input user name and password as authentication information. Then, the UI control unit 402 displays the main screen 741 of FIG. 7E on the display 214.

When a user touches the icon 742d on the main screen 741 of FIG. 7E, in step S604, the UI control unit 402 displays a hold print screen illustrated in FIG. 7C on the display 214.

On the hold print screen, in a region 720, the user name included in the user information described above is displayed. However, in a case where the user information is not set at this stage, the user name can be set at this screen.

On the hold print screen, a region 721 is a region for selecting whether or not to input a password for secure print data. By a user operates a switch 721a in the region 721, inputting a password for secure print data (ON) or not inputting a password for secure print data (OFF) can be selected. Note that selecting whether or not to input a password for secure print data is not necessary, and, for example, the region 721 may not be provided and the settings may be that a password for secure print data is always input.

A region 722 is a region for displaying a message prompting the user to bring the data processing device 101 into close proximity to the NFC communication unit 310 or the BLE communication unit 311 of the image forming device 104.

When the user brings the data processing device 101 into close proximity to the NFC communication unit 310 or the BLE communication unit 311 of the image forming device 104, in step S605, the connection unit 404 obtains the device information by near field communication. Then, the connection unit 404 establishes wireless LAN communications with the image forming device 104 using the obtained device information.

After wireless LAN communications have been established between the data processing device 101 and the image forming device 104, in step S606, the UI control unit 402 displays a secure password input screen 730 illustrated in FIG. 7D on the display 214.

A region 731 is a region for inputting a password for secure print data. The region 731 is put in a state that is capable of receiving the input of a password in a case where the switch 721a is set to “ON” and is input in a state that is incapable of receiving the input of a password in a case where the switch 721a is set to “OFF”. In a case where the switch 721a is set to “ON”, the user can input a password in the region 731 by operating the touch panel 215 (step S607). The input password is managed by the management unit 407.

When the user operates the touch panel 215 and touches the OK button, in step S608, the control unit 406 transmits a print instruction including a print instruction command, the user information set at the user information input screen 710 of FIG. 7B, and the password (the password managed by the management unit 407) input at the secure password input screen 730 of FIG. 7D to the image forming device 104 via wireless LAN communication established via the NFC communication unit 210 or the BLE communication unit 211. Note that in a case where the switch 721a is set to “OFF”, the OK button can be touched without inputting anything in the region 731. Thus, in this case, the control unit 406 transmits a print instruction including a print instruction command and the user information set at the user information input screen 710 of FIG. 7B to the image forming device 104 via wireless LAN communication. Here, the print instruction may be transmitted via the NFC communication unit 210 or the BLE communication unit 211.

Note that the UI control unit 402 displays an in running screen 750 illustrated in FIG. 7F on the display 214 while the print instruction is transmitted and, when the transmission of the print instruction is complete, displays the main screen 741 described above on the display 214.

In step S609, the control unit 505 receives the print instruction transmitted from the data processing device 101 via the wireless LAN communication unit 312. Also, the authentication unit 503 performs user authentication on the basis of user information included in the received print instruction. The technology of authenticating a user using a user name and password included in the print instruction is known, and thus description thereof is omitted. Note that in a case where the image forming device 104 is set not to perform authentication, this authentication can be omitted. In a case where authentication is successful, the process proceeds to step S610.

In step S610, the control unit 507 obtains the print data (for example, the print data registered in association with the user name included in the user information) corresponding to the user information included in the print instruction from the print data group stored (registered) in the HDD 305 after being received by the reception unit 506 from various devices, such as the data processing device 101, the cloud server 105, the information processing device 106, and the like.

In step S611, in a case where a password for printing is set in the print data obtained in step S610, the control unit 507 determines whether or not the password and the “password for secure print data” included in the print instruction match. As a result of the determination, in a case where it is determined to be a match, print data authentication is determined to have been successful, and the process proceeds to step S612. On the other hand, as a result of the determination, in a case where it is determined to be not a match, print data authentication is determined to have failed, and an error or the like is output and the processing of step S612 is not executed. Note that in a case where a password for printing is not set in the print data obtained in step S610, the process proceeds to step S612.

In step S612, in accordance with the print command included in the print instruction, the control unit 507 generates a print image on the basis of the print data obtained in step S610 and outputs the generated print image to the printer 314 to print the print image on a printing medium.

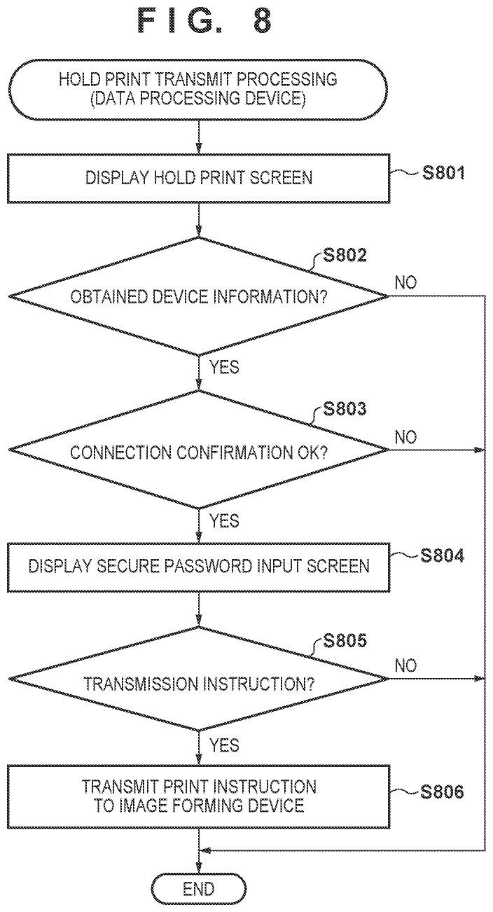

Next, the operations of the data processing device 101 in the sequence illustrated in FIG. 6 will be described according to the flowchart of FIG. 8.

In step S801, when a user touches the icon 742d on the main screen 741 of FIG. 7E, the UI control unit 402 displays a hold print screen illustrated in FIG. 7C on the display 214. In the example described below, the switch 721a is set to “ON” at the hold print screen illustrated in FIG. 7C.

In step S802, the connection unit 404 obtains the device information of the image forming device 104. In a case where the device information can be obtained, the process proceeds to step S803, and in a case where a state occurs where the device information cannot be obtained, for example the hold print screen is closed based on a user operation, the process according to the flowchart of FIG. 8 ends.

A method of obtaining device information is, for example, following method. By bringing the NFC communication unit 210 or the BLE communication unit 211 of the data processing device 101 into close proximity with the NFC communication unit 310 or the BLE communication unit 311 of the image forming device 104 and executing near field communication, the device information (IP address, MAC address, or the like) for connecting to a wireless LAN is obtained. Note that the method of obtaining the device information is not limited thereto. For example, a method of reading a QR code (registered trademark) displayed on the operation unit 307 of the image forming device 104 using a camera or the like provided on the data processing device 101, or a method of having the user input the device information on the display 214 of the data processing device 101 may be used.

In step S803, the connection unit 404 establishes wireless LAN communications with the image forming device 104 using the device information obtained in step S802. In a case where a wireless LAN connection is established with the image forming device 104, the process proceeds to step S804. In a case where a wireless LAN connection is not established with the image forming device 104, that a connection is not established is displayed on the display 214, for example, and the process according to the flowchart of FIG. 8 ends.

In step S804, the UI control unit 402 displays the secure password input screen 730 illustrated in FIG. 7D on the display 214. As described above, the user inputs a password for secure print data in the region 731 of the secure password input screen 730, and the input password is managed by the management unit 407.

In step S805, the control unit 406 determines whether or not the user has operated the touch panel 215 and touched the OK button of the secure password input screen 730 (input a transmission instruction). In a case where the determination result is that a transmission instruction has been input, the process proceeds to step S806. In a case where a transmission instruction has not been input, the process according to the flowchart of FIG. 8 ends.

In step S806, the control unit 406 transmits a print instruction including a print instruction command, user information, and a password (the password managed by the management unit 407) to the image forming device 104 via the wireless LAN communication unit 212. As described above, in a case where the switch 721a is set to “OFF”, the control unit 406 transmits a print instruction including a print instruction command and the user information to the image forming device 104 via the wireless LAN communication unit 212. The UI control unit 402 displays the in running screen 750 of FIG. 7F on the display 214 while the print instruction is transmitted and, when the transmission of the print instruction is complete, displays the main screen 741 described above on the display 214.

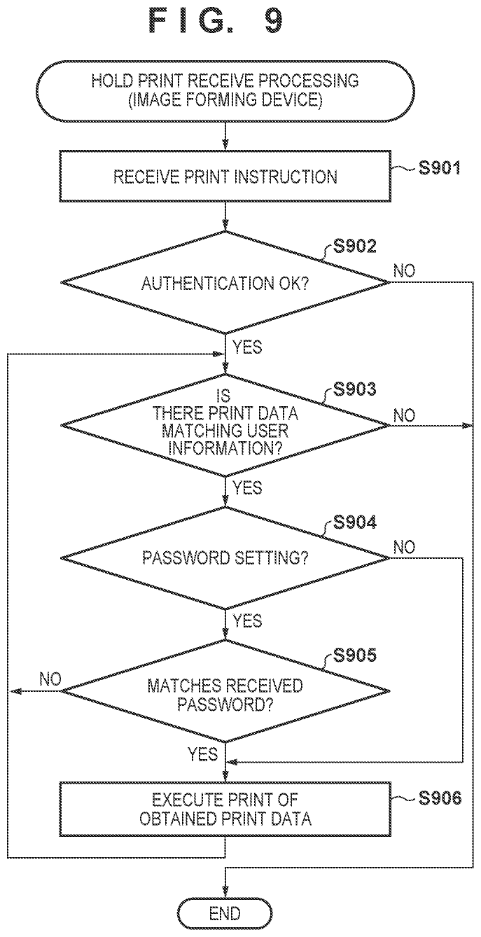

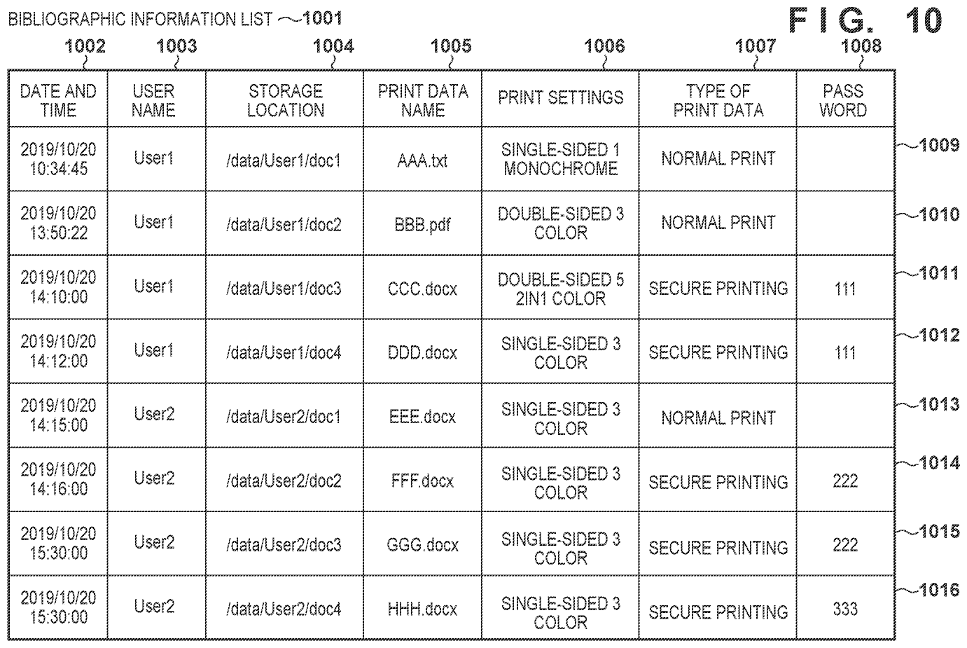

Next, the operations of the image forming device 104 in the sequence illustrated in FIG. 6 will be described according to the flowchart of FIG. 9.

In step S901, the control unit 505 receives the print instruction transmitted from the data processing device 101 via the wireless LAN communication unit 312.

In step S902, the authentication unit 503 performs user authentication on the basis of user information included in the print instruction received in step S901. In a case where the authentication is successful, the process proceeds to step S903. In a case where the authentication fails, the process according to the flowchart of FIG. 9 ends. Note that, as described above, in a case where the image forming device 104 is set not to perform authentication, this authentication is omitted and the process proceeds to step S903.

In step S903, a control unit 507 searches for the print data corresponding to the user information included in the print instruction from the print data group stored (registered) in the HDD 305. In a case where the search finds the print data corresponding to the user information included in the print instruction from the print data group stored (registered) in the HDD 305, the process proceeds to step S904. In a case where the print data is not found, the process according to the flowchart of FIG. 9 ends.

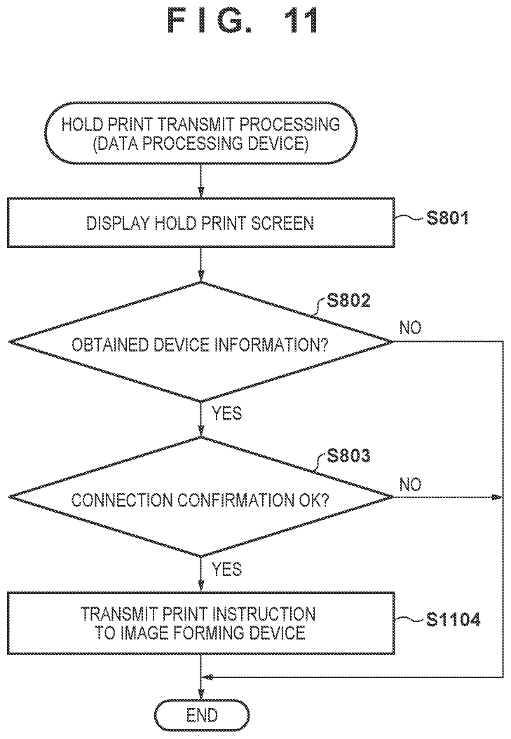

As illustrated in FIG. 10, a table 1001 in which the print data received from the devices, such as the data processing device 101, the cloud server 105, the information processing device 106, and the like, and the user information of the device that transmitted the print data are associated and registered is stored in the HDD 305.

In column 1002, the date and time that the print data and the user information was stored (registered) in the HDD 305 are registered. In column 1003, the user name included in the user information is registered. In column 1004, the path indicating the storage location of the print data and the user information in the HDD 305 is registered. In column 1005, the print data name included in the print data is registered. In column 1006, the print settings included in the print data are registered. In column 1007, the print data type (whether it is secure print data (secure print) or nonsecure print data (normal print)) is registered.

In column 1008, the password (the password for secure print data) set for the print data corresponding to secure print data is registered.

In step S903, the control unit 507 searches, in the column 1003 of the table 1001 of FIG. 10, for the row where the user name included in the user information included in the print instruction is registered and identifies the row found via the search as the target row.

In a case where the user name included in the user information included in the print instruction is “User 1”, the control unit 507 searches from the top row of the table 1001 for the row where “User 1” is registered in the column 1002. With such a search, in the first step S903, row 1009 is found as the target row, in the second step S903, row 1010 is found as the target row, and in the third step S903, row 1011 is founded as the target row. By finding a target row, a print data corresponding to the target row can be identified. Thus, as the result, in step S903, print data corresponding to the user information is found. Also, the “print data corresponding to the user information” here is not limited to print data transmitted from the data processing device 101. For example, print data transmitted with the same user information from a device other than the data processing device 101 is also included in the “print data corresponding to the user information”.

Next, in step S904, the control unit 507 determines whether or not a password for printing is set for the print data found in the search in step S903. For example, in a case where the row 1009 is found as the target row in step S903, “normal print” is registered in the column 1007 of the row 1009. Thus, in this case, it is determined that “no password is set for the print data”. For example, in a case where the row 1011 is found as the target row in step S903, “secure print” is registered in the column 1007 of the row 1011. Thus, in this case, it is determined that “a password is set for the print data”.

As a result of the determination, in a case where a password for printing is set in the print data found by the search in step S903, the process proceeds to step S905. On the other hand, in a case where a password for printing is not set in the print data found in the search in step S903, the process proceeds to step S906.

In step S905, the control unit 507 determines whether or not the password (the password registered in the column 1008 of the target row) set in the print data matches the “password for secure print data” included in the print instruction.

As a result of the determination, in a case where it is determined to be a match, print data authentication is determined to have been successful, and the process proceeds to step S906. On the other hand, as a result of the determination, in a case where it is determined to not be a match, print data authentication is determined to have failed, and the process proceeds to step S903.

In step S906, the control unit 507 generates a print image on the basis of the print data (the print data stored at the path registered in the column 1004 of the target row) identified by the search in step S903 according to the print command included in the print instruction. Then, the control unit 507 outputs the generated print image to the printer 314 and makes the printer 314 print based on the print settings registered in the column 1008 of the target row. Then, the process proceeds to step S903.

In this manner, according to the present embodiment, by transmitting the print instruction to the image forming device 104 from the data processing device 101, an instruction can be issued for printing based on the print data held in the image forming device 104 without operation of the operation unit 307.

Also, because the password for secure print data is obtained before the print instruction is transmitted to the image forming device 104, it does not need to store the password for secure print data in the data processing device 101.

### Second Embodiment

In the following embodiments including the present embodiment, difference from the first embodiment will be described, assuming that the following embodiments are similar to the first embodiment unless otherwise specified. In the first embodiment, a screen for inputting a password for secure print data is displayed on the display 214 of the data processing device 101 before the print instruction is transmitted. In the present embodiment, a screen for inputting a password for secure print data is displayed on a touch panel screen provided in the operation unit 307 of the image forming device 104.

The operations of the data processing device 101 according to the present embodiment will be described according to the flowchart of FIG. 11. In FIG. 11, processing steps that are similar to the processing steps illustrated in FIG. 8 are given the same step number and description thereof is omitted. In step S803 according to the present embodiment, when a wireless LAN connection with the image forming device 104 is established, the process proceeds to step S1104.

In step S1104, the control unit 406 transmits a print instruction including a print instruction command and the user information to the image forming device 104 via the wireless LAN communication unit 212.

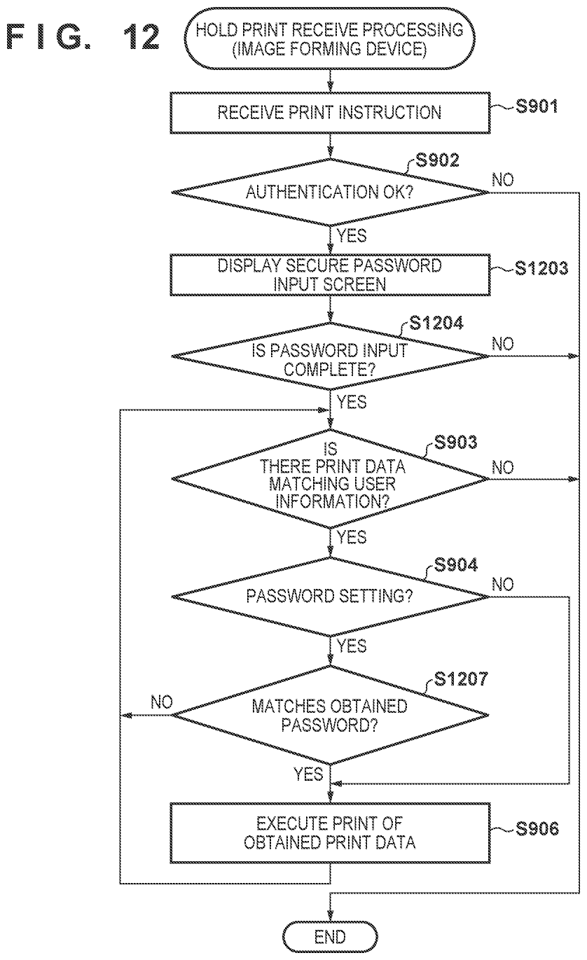

Next, the operations of the image forming device 104 according to the present embodiment will be described according to the flowchart of FIG. 12. In FIG. 12, processing steps that are similar to the processing steps illustrated in FIG. 9 are given the same step number and description thereof is omitted.

In a case where the authentication in step S902 is successful, the process proceeds to step S1203. In a case where the authentication fails, the process according to the flowchart of FIG. 12 ends. Note that, as described above, in a case where the image forming device 104 is set not to perform authentication, this authentication is omitted and the process proceeds to step S1203.

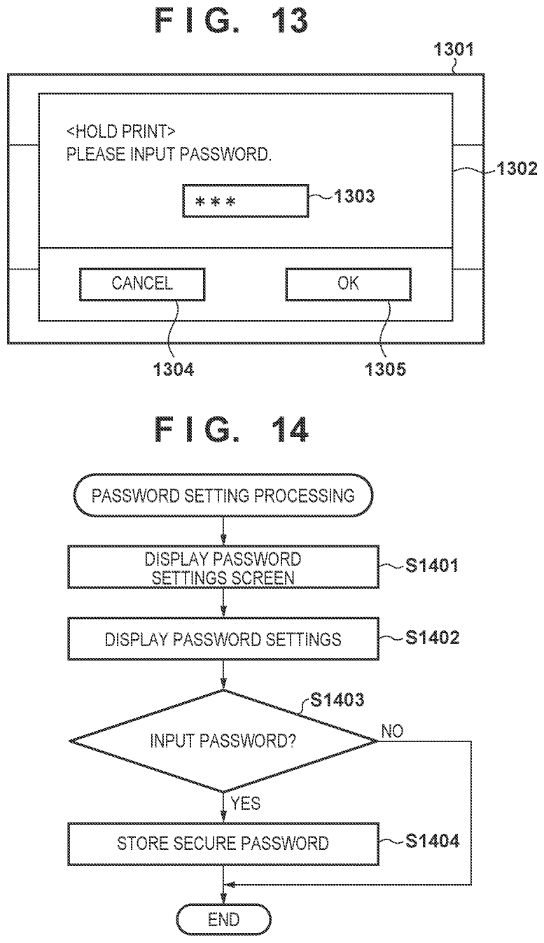

In step S1203, the UI control unit 502 displays a secure password input screen 1302 illustrated in FIG. 13 on a touch panel screen 1301 of the operation unit 307. A region 1303 is a region for inputting a password for secure print data.

In step S1204, the control unit 507 determines whether or not a user has touched an OK button 1305 after inputting a password for secure print data in the region 1303 (in other words, password input is complete). As a result of the determination, in a case where password input is complete, the process proceeds to step S903. On the other hand, in a case where password input is not complete, for example a cancel button 1304 is touched, the process according to the flowchart of FIG. 12 ends.

The secure password input screen 1302 may always be displayed in a case where a print instruction has been received by the image forming device 104 from the data processing device 101, or the secure password input screen 1302 may be displayed in a case where information requesting password input is included in the print instruction.

In step S904, in a case where a password for printing is set in the print data found in the search in step S903, the process proceeds to step S1207. On the other hand, in a case where a password for printing is not set in the print data found in the search in step S903, the process proceeds to step S906.

In step S1207, the control unit 507 determines whether or not the password (the password registered in the column 1008 of the target row) set in the print data matches the “password for secure print data” input in the region 1303. As a result of the determination, in a case where it is determined to be a match, print data authentication is determined to have been successful, and the process proceeds to step S906. On the other hand, as a result of the determination, in a case where it is determined to not be a match, print data authentication is determined to have failed, and the process proceeds to step S903.

In this manner, according to the present embodiment, compared to the first embodiment, an input operation of a password is made on the operation unit 307, however, because the password is not transmitted via the network 103, the present embodiment has better password security than the first embodiment.

### Third Embodiment

In the first embodiment, before a print instruction is transmitted, a secure password input screen is displayed and input of a password for secure print data is received, and when a password is input, a print instruction including the password is transmitted to the image forming device 104.

In the present embodiment, the password for secure print data is set in advance and stored in the data processing device 101. When the data processing device 101 establishes a wireless LAN connection with the image forming device 104, the preset and stored password is included in the print instruction and transmitted to the image forming device 104 without the secure password input screen being displayed and without password input being received.

The user sets the password for secure print data at a password settings screen in advance as the initial settings for transmitting the print instruction to the image forming device 104. The processing executed by the data processing device 101 to set the password for secure print data at the password settings screen will now be described according to the flowchart of FIG. 14.

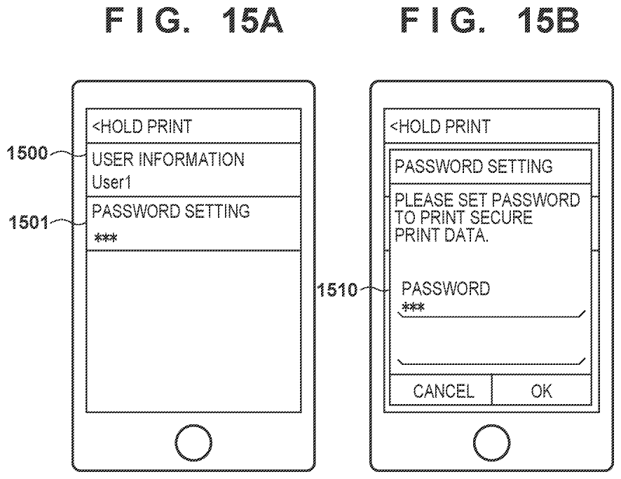

When a user operates the touch panel 215 and inputs a activate instruction for the password settings screen, in step S1401, the UI control unit 402 displays the password settings screen illustrated in FIG. 15A on the display 214.

In a region 1500, the user name included in the user information is displayed. A button 1501 is a button for instructing settings of a password for secure print data. When a user touches the button 1501, the process proceeds to step S1402.

In step S1402, the UI control unit 402 displays the screen illustrated in FIG. 15B. At the screen of FIG. 15B, a region 1510 is a region for inputting a password for secure print data. The user operates the touch panel 215 and inputs the password for secure print data in the region 1510.

In step S1503, the UI control unit 402 determines whether or not the OK button of the screen illustrated in FIG. 15B has been touched by the user. As a result of the determination, in a case where the OK button has been touched, it is determined that a password for secure print data has been input, and the process proceeds to step S1404. On the other hand, as a result of the determination, in a case where a cancel button of the screen of FIG. 15B has been touched, the process according to the flowchart of FIG. 14 ends.

In step S1404, the management unit 407 manages the password for secure print data input in the region 1510.

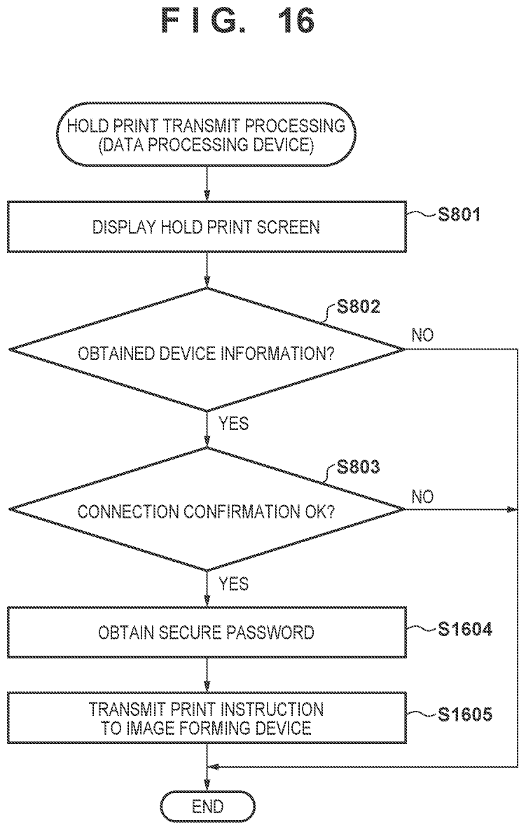

Next, the processing executed by the data processing device 101 to transmit a print instruction to the image forming device 104 will be described according to the flowchart of FIG. 16. Note that in FIG. 16, processing steps that are similar to the processing steps illustrated in FIG. 8 are given the same step number and description thereof is omitted.

In step S803, when a wireless LAN connection with the image forming device 104 is established, the process proceeds to step S1604. However, in a case where a wireless LAN connection is not established with the image forming device 104, that a connection is not established is displayed on the display 214, for example, and the process according to the flowchart of FIG. 16 ends.

In step S1604, the control unit 406 obtains the password managed by the management unit 407 (the password input in the region 1510 of the screen of FIG. 15B).

In step S1605, the control unit 406 transmits a print instruction including a print instruction command, user information, and the password obtained in step S1604 to the image forming device 104 via the wireless LAN communication unit 212. As described above, in a case where the switch 721a is set to OFF, the control unit 406 transmits a print instruction including a print instruction command and the user information to the image forming device 104 via the NFC communication unit 210 or the BLE communication unit 211. The UI control unit 402 displays the in running screen 750 of FIG. 7F on the display 214 while the print instruction is transmitted and, when the transmission of the print instruction is complete, displays the main screen 741 described above on the display 214.

In the present embodiment as described above, a password for secure print data is set in advance and the password for secure print data set in advance is included in the print instruction and is transmitted without input being requested for the password for secure print data when transmitting the print instruction. According to such a configuration, when printing, neither the data processing device 101 and the image forming device 104 need to input the password for secure print data. In other words, by only touching the image forming device 104 with the data processing device 101 by a user, printing processing of all of the print data associated with the user can be performed. Selection of the print data associated with the user and input of the password for secure print data is not needed to be performed when processing is executed.

The values, processing timing, processing order, configuration and operation method of screens, configuration of instructions and data, and the like used in the description above are examples for facilitating a detailed description, and no such limitation to the examples is intended.

Also, a part or all of the embodiments described above may be combined as appropriate to be used. Furthermore, a part or all of the embodiments described above may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-090826, filed May 25, 2020, which is hereby incorporated by reference herein in its entirety.

What is claimed is:

1. A system comprising devices that include an image forming device and a terminal device:
wherein the terminal device comprises:
a first memory; and
a first processor in communication with the first memory, wherein the first processor transmits a print instruction including user information of a user of the terminal device to the image forming device in a case where near field communication with the image forming device is established; and
wherein the image forming device comprises:
a second memory; and
a second processor in communication with the second memory, wherein the second processor identifies print data corresponding to the user information included in the print instruction from among a plurality of held print data and controls printing based on the identified print data on the basis of a password for printing.

2. The system according to claim 1, wherein
the first processor further performs:
receiving input of a password in a case where the near field communication with the image forming device is established, and
transmitting a print instruction including the password and the user information to the image forming device upon the transmission, and
the second processor controls printing based on the identified print data on the basis of the password included in the print instruction upon the control.

3. The system according to claim 1, wherein
the second processor further performs:
receiving input of a password; and
controlling printing based on the identified print data on the basis of the password upon the control.

4. The system according to claim 1, wherein
upon the transmission, the first processor transmits a print instruction including a password set in advance and the user information to the image forming device; and
upon the control, the second processor controls printing based on the identified print data on the basis of the password included in the print instruction.

5. The system according to claim 1, wherein
upon the control, the second processor executes printing based on the identified print data in a case where authentication based on the password is successful.

6. The system according to claim 1,
wherein the terminal device establishes wireless LAN communication with the image forming device on the basis of near field communication with the image forming device being established, and transmits a print instruction via the wireless LAN communication upon the transmission.

7. A control method of a system comprising devices that include an image forming device and a terminal device,
wherein the terminal device transmits a print instruction including user information of a user of the terminal device to the image forming device in a case where near field communication with the image forming device is established; and
wherein the image forming device identifies print data corresponding to the user information included in the print instruction from among a plurality of held print data and controls printing based on the identified print data on the basis of a password for printing.

8. A terminal device for communicating with an image forming device, comprising:
a memory; and
a processor in communication with the memory, wherein the processor performs:
receiving input of user information and a password; and
transmitting a print instruction including the password and the user information to the image forming device.

9. A non-transitory computer-readable storage medium for storing a computer program for causing a computer of a terminal device for communicating with an image forming device to function as:
a reception unit configured to receive input of user information and a password; and
a transmission unit configured to transmit a print instruction including the password and the user information whose input is received by the reception unit to the image forming device.
